(19) United States
(12) Patent Application Publication
(10) Pub. No.: US 2010/0325143 A1
(43) Pub. Date: Dec. 23, 2010

(54) AUTOMATICALLY LINKING GEOGRAPHIC TERMS TO GEOGRAPHIC INFORMATION

(75) Inventors: Bernhard Straub, Karlsruhe (DE); Mihai Antonenco, Bucuresti (RO)

Correspondence Address: KNOBBE MARTENS OLSON & BEAR LLP, 2040 MAIN STREET, FOURTEENTH FLOOR, IRVINE, CA, 92614, US

(73) Assignee: ROUTE 66 SWITZERLAND GMBH, Pfaffikon (CH)

(21) Appl. No.: 12/741,351

(22) PCT Filed: Nov. 13, 2007
(86) PCT No.: PCT/CH07/00570

§ 371 Date: Sep. 2, 2010

(51) Int. Cl. G06F 17/30

(52) U.S. Cl. 707/769; 707/E17.018

(57) ABSTRACT

Identified in the textual data of a web page (3) are words that have a geographic association, by looking up each word in a location database (13). From these words, sentences of one or more words are generated. Geographic references (32) are identified in the textual data by looking up in the location database (13) matching geographic entries corresponding to one of the sentences. To each geographic reference (32) assigned are the geographic coordinates assigned in the location database (13) to the respective matching geographic entry. Furthermore, the geographic references (32) are linked on the web page (3) to executable program code enabling a user to access location specific information based on the geographic coordinates associated with the respective geographic reference (32). Any web page (3) and particularly any geographic reference (32) on a web page (3) can thereby be enabled with location specific information and navigation functionality.

### FIELD OF THE INVENTION

The present invention relates to a computer-implemented method and devices for geocoding. Specifically, the present invention relates to a computer-implemented method and devices for assigning geographic coordinates to geographic references included in textual data.

### BACKGROUND OF THE INVENTION

The term “geocoding” relates to assigning geographic coordinate information to textual geographic references such as postal addresses or other descriptions of geographic locations, e.g. points of interest. Typically, coordinates used in geodesy and navigation include latitude and longitude values, e.g. WGS 84 coordinates defined by the World Geodetic System. In many conventional geocoding systems, the user must enter textual address information such as street, city, state, postal code (e.g. a ZIP code), and/or country. Based on the received categorized address information, a server-implemented geocoding module determines corresponding geographic coordinates through database lookup. Although such geocoding services are quite useful, a user is required to access one of a few geocoding services on the Internet. Furthermore, the user is required to perform manual data entry and enter the address information in a specific and limited format.

U.S. Pat. No. 6,934,634 describes a server-based geocoding system that provides geographic coordinate information in exchange to postal addresses that are received on the server or extracted from documents such as web pages. According to U.S. Pat. No. 6,934,634, postal addresses are extracted from documents based on predetermined address rules. Specifically, based on these address rules, located in the text are possible address terms that refer to possible location names. For example, a county name should be followed by the word county. Street names are generally identified by terms such as “street,” “road,” “drive,” “parkway,” “pkwy,” etc. In addition, the geocoding system of U.S. Pat. No. 6,934,634 looks for capitalization that is consistent with a written address, e.g. it may be requires that street and city names are capitalized. Furthermore, street names may be required to be preceded by a number and ZIP codes may be identified as five-digit strings. For determining the geographic coordinates, a standardized version of the identified address terms is looked up in a database. The geocoding system according to U.S. Pat. No. 6,934,634 appears to work well for geographic references provided as properly formatted postal addresses; however, geographic references on a web page may be missed, if the references are given without conventional address terms or not provided as a postal address at all. Moreover, in order to use the geocoding system, a user is still required to access the remote server.

### SUMMARY OF THE INVENTION

It is an object of this invention to provide a computer-implemented method and device for geocoding. In particular, it is an object of the present invention to provide a computer-implemented method and devices for assigning geographic coordinates to geographic references included in textual data. It is a further object of the present invention to provide a computer-implemented method and a mobile communication terminal for geocoding, which method and mobile communication terminal do not have at least some of the disadvantages of the prior art. In particular, it is an object of the present invention to provide a computer-implemented method and a mobile communication terminal for assigning geographic coordinates to geographic references included in textual data, which method and mobile communication terminal are not limited to geocoding of postal addresses defined by predetermined address rules.

According to the present invention, these objects are achieved particularly through the features of the independent claims. In addition, further advantageous embodiments follow from the dependent claims and the description.

According to the present invention, the above-mentioned objects are particularly achieved in that, for assigning geographic coordinates to geographic references included in textual data, identified in the textual data are words having a geographic association (or connotation) by looking up each word in a location database. From the words found in the location database to have a geographic association (connotation), sentences of one or more words are generated. A sentence of more than one word includes words that are located in the textual data within a defined proximity of each other, for example, consecutive words or words that are not separated from each other by more than one, two or three other words. The geographic references are identified in the textual data by looking up in the location database matching geographic entries corresponding to one of the sentences. Finally, assigned to each geographic reference are the geographic coordinates assigned in the location database to the respective matching geographic entry. By checking a possible geographic association for all the words in the textual data, geocoding is not limited to postal addresses having a predetermined address format. Furthermore, by considering sentences of possibly non-consecutive words as geographic references, geocoding is extended to textual data that would not be considered by conventional geocoding systems.

In a preferred embodiment, the textual data is retrieved from a web page, and, on the web page, the geographic references are linked to executable program code that enables a user to access location specific information based on the geographic coordinates associated with the respective geographic reference. For example, the textual data retrieved from the web page is in the form of markup language such as HTML (Hypertext Markup Language) or XML (Extended Markup Language). For example, the executable program code is a so called “plug-in” for a conventional web browser. The executable program code enables the user to select one or more functions to be performed, for example, showing the respective geographic reference on a map, providing navigational information related to the respective geographic reference, adding the respective geographic reference to a route on a navigation system, sending the coordinates of the respective geographic reference to a defined recipient, and/or saving the respective geographic reference in a defined data store, e.g. in the local memory of a (mobile) communication terminal. By linking the geographic references with the executable program code, any web page, and particularly any geographic references on a web page, is enabled with location specific information and navigation functionality, without the original web page having to be configured for that purpose. Thus, the automatically linked executable program code enhances conventional web pages with contextual menus associated with geographic references included on the web page. For example, the geographic references are highlighted or marked otherwise on the web page, and by clicking on the highlighted geographic reference, the user is provided with the contextual menu, enabling the user to select one of the location-specific information or navigation functions related to the respective geographic reference.

In a further preferred embodiment, the location database is stored on a communication terminal, particularly a mobile communication terminal, and the web page is retrieved on the communication terminal from a remote web server. Moreover, the geocoding is performed on the communication terminal by executable program code, preferably loaded on the communication terminal as a plug-in for a conventional web browser. Particularly, performed on the communication terminal are the steps of identifying the words that have a geographical association, generating the sentences from these words, identifying the geographic references, and assigning the geographic coordinates to the geographic references. Moreover, performed on the communication terminal are the steps of linking the identified geographic references to the executable program code that enables the user to access the location-specific information based on the geographic coordinates associated with the respective geographic reference. Storing the location database on the communication terminal and performing the geocoding on the communication terminal relieves the (mobile) user from the dependence on remote geocoding servers and communication costs associated with accessing the remote server.

In an embodiment, prior to identifying words with a geographic association, common abbreviations of geographic terms are expanded, by looking up each word of the textual data in the location database. Thus, for geocoding purposes, any known “geographic” abbreviation in the textual data is expanded by its full, unabbreviated expression.

In a further embodiment, if no geographic reference was identified for a sentence of words having a geographic association, the sentence is reduced to a subset of these words, by removing repeatedly a selected one of the words included in the sentence. Subsequently, the geographic reference is identified in the textual data, by looking up in the location database matching geographic entries corresponding to the subset of words. By looking up subsets of sentences, identification of geographic references is improved for cases where a reduced (partial) version of the geographic reference is stored in the location database and/or an irrelevant (superfluous) component (word) was included in the sentence.

In another embodiment, looking up of matching geographic entries is reduced to looking up cities in the location database, if only one word is included in the sentence.

In yet a further embodiment, a selected geographic entry is determined using additional selection criteria, if more than one matching geographic entry is identified for a geographic reference. For example, the selection criteria are based on the address of a communication terminal, the domain name associated with a web page, the size of population associated with the geographic entry, and/or a popularity index associated with the geographic entry.

In addition to a computer-implemented method for assigning geographic coordinates to geographic references included in textual data, the present invention also relates to a mobile communication terminal and a computer program product including computer program code means for controlling one or more processors of a communication terminal, particularly, a computer program product including a computer readable medium containing therein the computer program code means.

### BRIEF DESCRIPTION OF THE DRAWINGS

The present invention will be explained in more detail, by way of example, with reference to the drawings in which:

FIG. 1 shows a block diagram illustrating schematically an exemplary configuration of a communication terminal for assigning geographic coordinates to geographic references included in textual data retrieved from a remote web server via a telecommunication network.

FIG. 2 shows a flow diagram illustrating an example of a sequence of steps for assigning geographic coordinates to geographic references included in textual data.

FIG. 3 shows a block diagram illustrating an example of a web page extended with geocoding, location-specific information and navigation functionality.

### DETAILED DESCRIPTION OF THE PREFERRED EMBODIMENTS

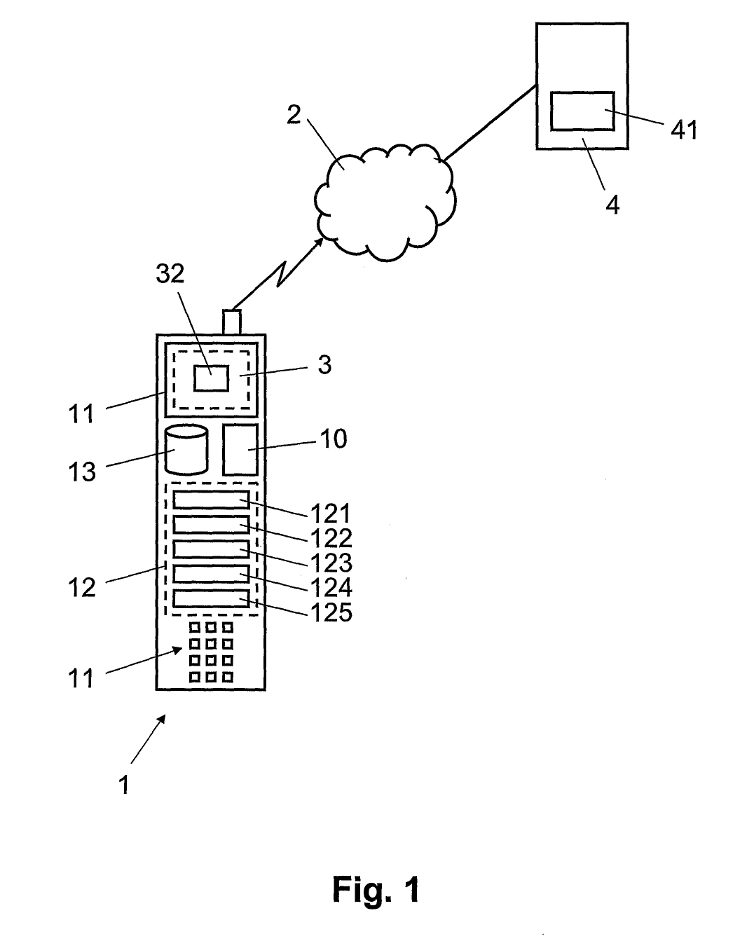

In FIG. 1, reference numeral 1 refers to a communication terminal, particularly a mobile communication terminal. The communication terminal 1 is, for example, a personal computer, a notebook or laptop computer, a mobile radio telephone or a personal digital assistant (PDA). The communication terminal 1 is configured to access and communicate with a remote computerized web server 4 via a telecommunications network 2. The telecommunications network 2 includes fixed networks and wireless networks. For example, the telecommunication network 2 includes a local area network (LAN), an integrated services digital network (ISDN), the Internet, a global system for mobile communication (GSM), a universal mobile telephone system (UMTS) or another mobile radio telephone system, and/or a wireless local area network (WLAN). The communication terminal 1 includes a web browser 10, such as Microsoft's Internet Explorer or Mozilla Firefox by the Mozilla Foundation, for accessing the web server 4 via the Internet. Furthermore, the communication terminal 1 includes a plug-in module 12 comprising various functional modules, namely a parser 121, a sentence generator 122, a reference detector 123, a geocoder 124, and a functional extension module 125. Preferably, the plug-in module 12 and thus the functional modules are implemented as programmed software modules and are stored in the communication terminal 1 as executable program code. The computer program code of the plug-in module 12 and thus the functional modules are stored in a computer program product, i.e. in a computer readable medium, either in memory integrated in the communication terminal 1 or on a data carrier that can be inserted into the communication terminal 1.

As illustrated schematically in FIG. 1, the communication terminal 1 further includes a location database 13. The location database 13 comprises for a defined geographic region geographic entries with full text search index. For example, the geographic region is defined for a specific continent, country, state, or the whole world. Each geographic entry includes a geographic location description comprising one or more words, e.g. the name of a city, village, community, street, or building; a street or postal address including postal code, street number; and/or the name of an organization or enterprise, etc. In an embodiment, a geographic entry further includes a geographic entry type associated with the geographic location description, e.g. type “city”, “street”, “building”, or “organization”, etc. Moreover, each geographic entry includes geographic coordinates assigned to the respective geographic location description, e.g. WGS 84 coordinates. In an embodiment, the location database 13 further comprises common abbreviations of geographic terms and their corresponding unabbreviated, full expressions, e.g. “str.” for “street”, “avn.” for “avenue”, or “twn.” for “town”, etc.

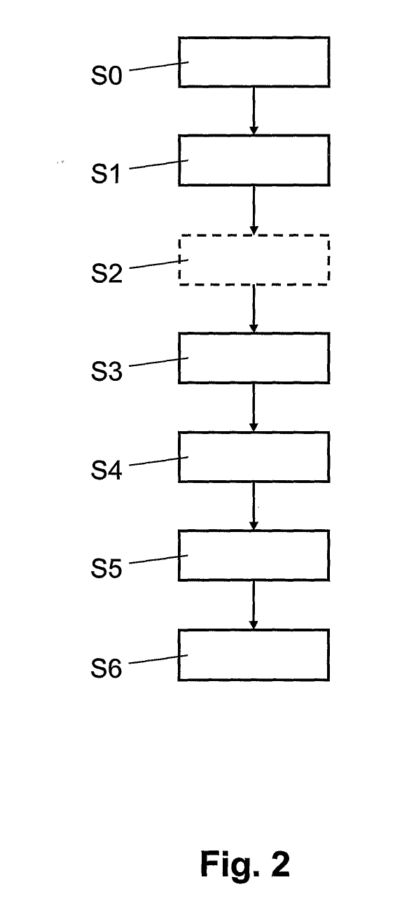

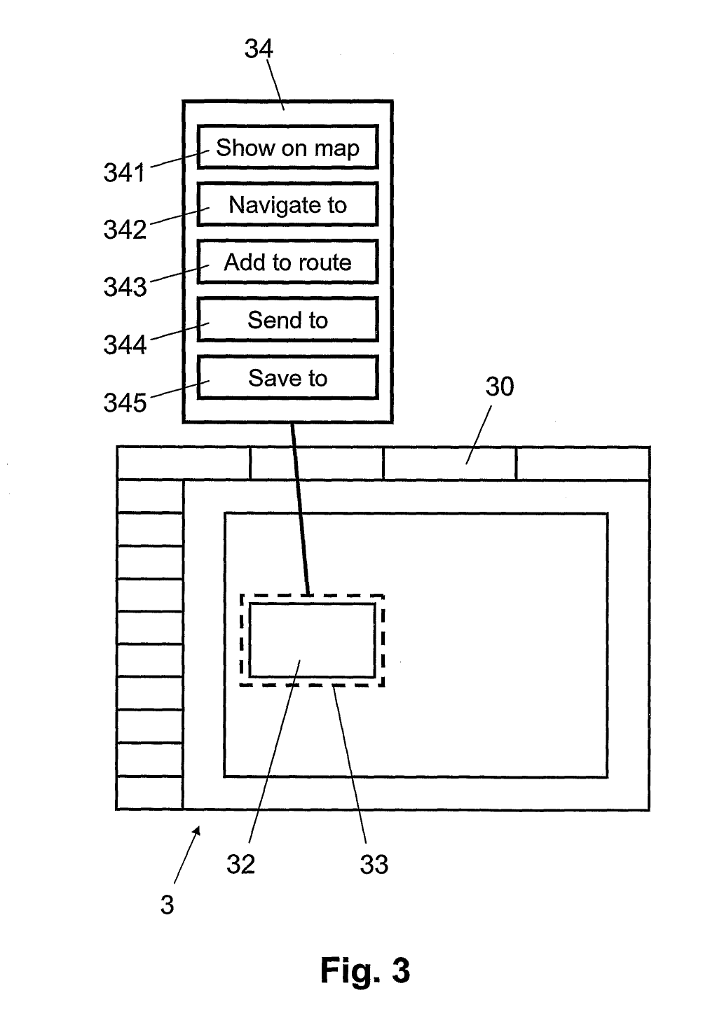

In the following paragraphs, described with reference to FIGS. 2 and 3 are the functionality associated with the functional modules and a possible sequence of steps executed in the communication terminal 1 for assigning geographic coordinates to geographic references included in textual data.

In preparatory step S0, the plug-in module 12 and the location database 13 are loaded and stored in the communication terminal 1.

In step S1, the user of the communication terminal 1 uses the browser 10 to access web server 4 and download a web page definition 41, e.g. by entering or activating an URL address (Uniform Resource Locator) using the operating elements 14 of the communication terminal 1. As illustrated schematically in FIG. 1, the web page definition 41 defines the layout of a web page 3 shown on display 11 of the communication terminal. For example, the layout of the web page 3 is defined in a markup language such as HTML or XML.

In optional step S2, upon loading of the web page definition 41, the parser 121 parses the textual data associated with the web page definition 41, e.g. the HTML or XML code, for abbreviations. The abbreviations are looked up by the parser 121 in the location database for matching common abbreviations of geographic terms. If a matching geographic abbreviation is found, the full, unabbreviated geographic term associated with the abbreviation is retrieved from the location database 13 and stored in the communication terminal 1 as an expansion of the abbreviated geographic term of the textual data included in the web page definition 41.

For example, in the exemplary text shown in Table 1, the parser 121 detects the abbreviation “Avn” and extends it with the unabbreviated expression “Avenue”.

TABLE 1
Lorem Bühl ipsum dolor sit amet, consectetuer adipiscing elit. Cras ut
enim non dapibus. Pellentesque non neque. Nulla et ipsum. Draisstrasse 20
Freiburg Mauris lorem adipiscing nulla, eget convallis lacus mi ac orci.
Albert-Ludwig-Universität in Freiburg im Breisgau Etiam euismod, turpis
eget venenatis egestas volutpat. Pellentesque habitant morbi tristique
Stuttgart senectus et netus et malesuada fames ac turpis egestas.
Edmonton Avn. Quisque aliquet velit.

In step S3, the parser 121 identifies individual words in the textual data associated with the web page definition 41. For each individual word, including the expanded abbreviations, the parser 121 determines whether the word has a geographic association or is possibly a house or street number. For determining words that have a geographic association, the parser 121 looks up the full, search index of the location database 13 for matching entries. If a matching entry is found, the respective word is marked and/or stored by the parser 121. Moreover, the parser 121 stores for the respective word and for a possible house or street number its relative position in the textual data of the web page definition 41.

For example, using a location database covering the German state of Baden-Würtemberg, in the expanded version of the text shown in Table 1, the parser 121 identifies the following words as having a geographical association: “Bühl”, “Draisstrasse”, “Freiburg”, “Albert”, “Ludwig”, “Universität”, “Freiburg”, “im”, “Breisgau”, “Stuttgart”, “Edmonton”, and “Avenue”. Thus, the parser 121 stores these words and their respective position as shown in Table 2.

TABLE 2

| Word | Position |
|---|---|
| Bühl | 2 |
| Draisstrasse | 21 |
| 20 (number) | 22 |
| Freiburg | 23 |
| Albert | 34 |
| Ludwig | 35 |
| Universität | 36 |
| Freiburg | 38 |
| Im | 39 |
| Breisgau | 40 |
| Stuttgart | 52 |
| Edmonton | 62 |
| Avenue | 63 |

In step S4, the sentence generator 122 generates, from the words having a geographic association or being a possible house or street number, word groups including a sequence of one or more words. From hereon, these word groups are referred to as “sentences”. A sentence of more than one word includes words that are located in the textual data of the web page definition 41 within a defined proximity of each other. For example, a word is associated with a sentence, if the word's distance (difference in position) to another word associated with the sentence is not greater than a defined combination threshold, e.g. one, two or three. A sentence composed of just one word does not have any other words with a geographic association within its defined proximity.

For example, from the words and positions shown in Table 2, the sentence generator 122 generates the sentences shown in Table 3.

TABLE 3

Bühl
Draisstrasse 20 Freiburg
Albert Ludwig Universität Freiburg im Breisgau
Stuttgart
Edmonton Avenue

In step S5, the reference detector 123 identifies geographic references in the textual data of the web page definition 41. The reference detector 123 identifies geographic references by looking up in the location database 13 matching geographic entries corresponding to one of the sentences formed in step S4. If a sentence is composed of just one word, the reference detector 123 restricts the lookup to geographical entries of cities (entry type “city”) in the location database 13. If no matching geographic entries are found for a sentence composed of more than one words, the reference detector 123 forms subsets of the sentence by selectively removing one of the words included in the sentence. Subsequently, the reference detector 123 attempts to identify geographic references by looking up in the location database 13 matching geographic entries corresponding to one of the subsets of the sentence. This process is repeated until only subsets of one word remain and no matching geographic entry has been determined. If more than a defined number, e.g. a defined ambiguity threshold, of matching geographic entries have been found for a sentence, e.g. more than one, the reference detector 123 uses additional criteria to find the best match. For example, the reference detector 123 selects the matching geographic entry based on the (IP) address associated with the communication terminal 1 (e.g. limitation to the country code included in the address), the domain name associated with the web page (e.g. limitation to the country domain associated with the web page), the size of the population associated with the geographic entry (e.g. limitation to the largest city), and/or a popularity index associated with the geographic entry (e.g. limitation to the most popular city). The geographic references identified by matching geographic entries are marked and/or stored in the communication terminal 1.

For example, based on the sentences shown in Table 3, the reference detector 123 identifies and highlights in the expanded version of the exemplary text of Table 1 the geographic references as shown in Table 4.

TABLE 4
Lorem Bühl ipsum dolor sit amet, consectetuer adipiscing elit. Cras ut
enim non dapibus. Pellentesque non neque. Nulla et ipsum. Draisstrasse 20
Freiburg Mauris lorem adipiscing nulla, eget convallis lacus mi ac orci.
Albert-Ludwig-Universität in Freiburg im Breisgau Etiam euismod, turpis
eget venenatis egestas volutpat. Pellentesque habitant morbi tristique
Stuttgart senectus et netus et malesuada fames ac turpis egestas.
Edmonton Avenue Quisque aliquet velit.

In step S6, the geocoder 124 assigns to each geographic reference identified in step S5 the geographic coordinates assigned in the location database 13 to the respective matching geographic entry. Moreover, the geocoder 124 links the identified geographic references to the executable program code of the functional extension module 125. As is illustrated schematically in FIG. 3, the geocoder 124 also marks or highlights for available user interaction any identified geographic reference 32 included in a textual data section 31 of the web page 3. For example, identified geographic references 32 are marked or highlighted by means of a visual feature 33, such as an icon, a defined background color, and/or underlined, bolded or blinking text etc.

Responsive to the user selecting and activating the highlighted geographical reference 32, e.g. by clicking on the geographical reference 32, the executable program code of the functional extension module 125 is activated. The functional extension module 125 presents to the user an extension menu 34 with different functions that can be selected for execution by the user, e.g. by clicking a visual feature such as a function button or a menu item. Selecting the visual feature 341 labeled “Show on map” makes the functional extension module 125 show the respective geographic reference on a map, using its geographic coordinates. Selecting the visual feature 342 labeled “Navigate to” makes the functional extension module 125 provide to the user navigational information related to the respective geographic reference, e.g. as spoken and/or displayed navigation instructions. Consequently, the user can navigate from his/her current position obtained by GPS (Global Positioning System), for example, or from any other position to the highlighted postal address. Selecting the visual feature 343 labeled “Add to route” makes the functional extension module 125 add the respective geographic reference to a route on a navigation system, e.g. on display 11 of the communication terminal 1. Selecting the visual feature 344 labeled “Send to” makes the functional extension module 125 send the coordinates of the respective geographic reference to a recipient, e.g. selected from a list or entered as an address, by means of SMS (Short Messaging Service) MMS (Multimedia Messaging Service), Bluetooth or e-mail, for example. Selecting the visual feature 345 labeled “Save to” makes the functional extension module 125 save the respective geographic reference in a defined data store, e.g. in local memory of the communication terminal 1 or in a remote data store.

It should be noted that, in the description, the program code has been associated with specific functional modules and the sequence of the steps has been presented in a specific order, one skilled in the art will understand, however, that the computer program code may be structured differently and that the order of at least some of the steps could be altered, without deviating from the scope of the invention.

1. A computer-implemented method of assigning geographic coordinates to geographic references included in textual data, the method comprising:
identifying, in the textual data, words having a geographic association, by looking up each word in a location database;
generating, from the words having a geographic association, sentences of one or more words, a sentence of more than one word including words that are located in the textual data within a defined proximity of each other;
identifying the geographic references in the textual data, by looking up in the location database matching geographic entries corresponding to one of the sentences; and
assigning to each geographic reference the geographic coordinates assigned in the location database to the respective matching geographic entry.

2. The method of claim 1, further comprising retrieving the textual data from a web page; and linking on the web page the geographic references to executable program code, which executable program code enables a user to access location specific information based on the geographic coordinates associated with the respective geographic reference.

3. The method of claim 2, wherein the executable program code enables the user to select at least one from the following functions to be performed:
show the respective geographic reference on a map,
provide navigational information related to the respective geographic reference,
add the respective geographic reference to a route on a navigation system,
send the coordinates of the respective geographic reference to a defined recipient, and save the respective geographic reference in a defined data store.

4. The method of claim 2, further comprising:
storing the location database on a communication terminal, particularly a mobile communication terminal;
retrieving the web page on the communication terminal from a remote web server; and
performing on the communication terminal the identifying of words having a geographical association, the generating of sentences, the identifying of the geographic references, and the assigning of the geographic coordinates.

5. The method of claim 1, further comprising, prior to identifying words with a geographic association, expanding common abbreviations of geographic terms, by looking up each word in the location database.

6. The method of claim 1, further comprising reducing a sentence to a subset of words, by removing selectively one of the words included in the sentence when no geographic reference was identified for the sentence; and identifying the geographic reference in the textual data, by looking up in the location database matching geographic entries corresponding to the subset of words.

7. The method of claim 1, further comprising reducing the looking up of matching geographic entries to looking up cities in the location database when only one word is included in the sentence.

8. The method of claim 1, further comprising determining a selected geographic entry when more than one matching geographic entry is identified for a geographic reference, by using additional selection criteria based on at least one of an address of a communication terminal, a domain name associated with a web page, a size of population associated with the geographic entry, and a popularity index associated with the geographic entry.

9. A computer program product comprising physical computer storage that stores a computer program for controlling one or more processors of a communication terminal, that when executed by the one or more processors, causes the communication terminal to:
identify, in textual data, words having a geographic association, by looking up each word in a location database;
generate, from the words having a geographic association, sentences of one or more words, a sentence of more than one word including words that are located in the textual data within a defined proximity of each other;
identify geographic references in the textual data, by looking up in the location database matching geographic entries corresponding to one of the sentences; and
assign to each geographic reference geographic coordinates assigned in the location database to the respective matching geographic entry.

10. The computer program product of claim 9, wherein the computer program further directs the communication terminal to retrieve the textual data from a web page; and to link on the web page the geographic references to a computer that enables a user to select at least one from the following functions to be performed:
show the respective geographic reference on a map,
provide navigational information related to the respective geographic reference, add the respective geographic reference to a route on a navigation system,
send the coordinates of the respective geographic reference to a defined recipient, and
save the respective geographic reference in a defined data store.

11. A mobile communication terminal, comprising:
computer hardware configured to implement:
a parser configured to identify, in textual data, words having a geographic association, by looking up each word in a location database;
a sentence generator configured to generate, from the words having a geographic association, sentences of one or more words, a sentence of more than one word including words that are located in the textual data within a defined proximity of each other;
a reference detector configured to identify geographic references in the textual data, by looking up in the location database matching geographic entries corresponding to one of the sentences; and
a geocoder configured to assign to each geographic reference geographic coordinates assigned in the location database to the respective matching geographic entry.

12. The mobile communication terminal of claim 11, wherein the parser is further configured to retrieve the textual data from a web page; and the geocoder is further configured to link on the web page the geographic references to executable program code, which executable program code enables a user to select at least one from the following functions to be performed:
show the respective geographic reference on a map,
provide navigational information related to the respective geographic reference,
add the respective geographic reference to a route on a navigation system,
send the coordinates of the respective geographic reference to a defined recipient, and
save the respective geographic reference in a defined data store.
